(19) United States
(12) Patent Application Publication
(10) Pub. No.: US 2014/0007523 A1
(43) Pub. Date: Jan. 9, 2014

(54) STRAKES FOR UTILITY STRUCTURES

(71) Applicants: Mark Hugh Fairbairn, Red Wing, MN (US); Nathan Paul Perkins, Collierville, TN (US); Edward M. Jacobs, Germantown, TN (US); David Joseph Nahlen, Germantown, TN (US); Richard Morgan Slocum, Memphis, TN (US)

(72) Inventors: Mark Hugh Fairbairn, Red Wing, MN (US); Nathan Paul Perkins, Collierville, TN (US); Edward M. Jacobs, Germantown, TN (US); David Joseph Nahlen, Germantown, TN (US); Richard Morgan Slocum, Memphis, TN (US)

(73) Assignee: THOMAS & BETTS INTERNATIONAL, INC., Wilmington, DE (US)

(21) Appl. No.: 13/934,952

(22) Filed: Jul. 3, 2013

Related U.S. Application Data
(60) Provisional application No. 61/668,895, filed on Jul. 6, 2012.

(51) Int. Cl. F15D 1/10

(52) U.S. Cl. CPC F15D 1/10
USPC 52/84; 29/428

(57) ABSTRACT

A modular strake for reducing the effects of wind on utility structures is disclosed. The strake is comprised of individual fin sections that may easily be attached to a utility structure, preferably in a triple helix pattern. The modular strakes may be installed on a utility structure after is has been placed into service.

### FIELD OF THE INVENTION

The present invention is generally directed toward a device and method for reducing vibrations due to wind or water on structures.

### BACKGROUND OF THE INVENTION

Utility structures are used to position objects, such as cellular equipment, transmission lines and distribution lines, high above the ground. They typically incorporate at least one elongated tubular structure that is used to support the electrical lines or equipment. Due to the height of these structures, they are susceptible to dynamic wind forces that may be significant enough to result in vortex shedding and vibrations.

Different methods have been used to damp the vibrations caused by the air flow on these structures. One such method of damping vibrations is by incorporating structures onto the exterior of the elongated bodies that reduce vortex shedding. For example, chimney stacks may be constructed with long helical fins, known as strakes, that interrupt the dynamic wind forces. However, because the heavy utility structures are transported by truck and assembled at site, strakes are not incorporated into the exterior because they would be crushed.

### SUMMARY OF THE INVENTION

We disclose herein modular strakes for use with utility structures. The strakes are made of a series of adjacent fin sections that surround the utility structures. Specifically, it comprises at least a first fin section configured to partially surround the perimeter of the utility structure, that first fin section comprising of a strip of sheet metal that extends outward from the utility structure; and a second fin section configured to partially surround the perimeter of the utility structure, the second fin section also comprising of a strip of sheet metal that extends outward from said utility structure; such that the first fin section and said second fin section are attached at a point where they overlap.

We also disclose herein a method for attaching a strake to a utility structure comprising: positioning a first clip and a second clip to the perimeter of said utility structure; securing them to the utility structure; securing a first fin section of said strake to said first clip; securing said first fin section to a second fin section of said strake; and securing said second fin section to said second clip.

In addition, we disclose a device for reducing vortex-induced vibrations on a utility structure comprising a helical strake made of overlapping fin sections welded together and secured to the utility structure.

### BRIEF DESCRIPTION OF THE DRAWINGS

Further advantages of the invention will become apparent by reference to the detailed description of preferred embodiments when considered in conjunction with the drawings:

FIG. 1 depicts a utility structure having two support poles equipped with helical strakes as described herein.

FIG. 2a shows a perspective view of the electrical structure equipped with helical strakes.

FIG. 2b is a detailed view of Inset A of FIG. 2a.

FIG. 3a is a detailed view of Inset C of FIG. 2b.

FIG. 3b depicts a first layout of the helical fin.

FIG. 3c is another view of the layout of the helical fin as viewed from a cross sectional view of the utility structure as viewed along line B-B of FIG. 1.

FIG. 4a-4c depicts another embodiment of utility structure having two support poles equipped with helical strakes as described herein.

FIG. 4b depicts another embodiment of utility structure having two support poles equipped with helical strakes as described herein.

FIG. 4c depicts another embodiment of utility structure having two support poles equipped with helical strakes as described herein.

FIG. 5a depicts a flat pattern blank size of a fin section.

FIG. 5b depicts an isometric view of a fin section

FIG. 5c depicts a flat pattern of the fin section showing the axis of twist.

FIG. 5d depicts an elevation view of a fin section showing the axis of twist.

FIG. 5e depicts a view of the fin section showing the angle of twist as viewed along A-A.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

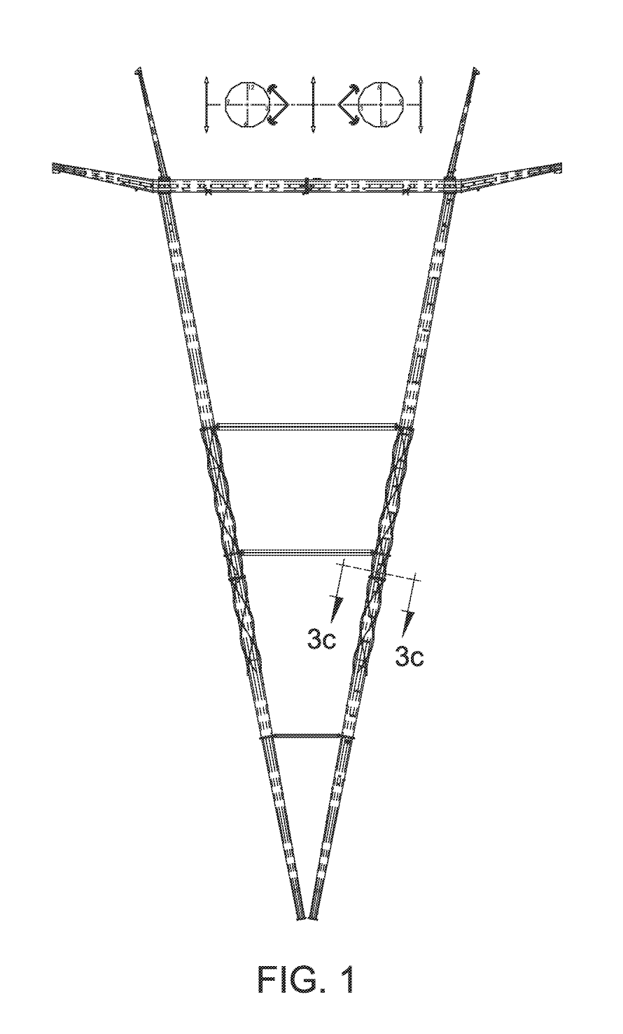

Utility structures 2 are typically elongated tubular structures comprising multiple flat sides that come together such that the sides form a simple polygon at a cross section, most commonly a dodecagon. Due to the length of these structures, they are shipped in sections and assembled on site. In many instances, each of the utility structure sections has a flange plate 16 at one end for connecting the sections to each other or for securing it to the ground. The utility structures 2 typically are tapered such that the diameter of the tubular structures changes over their length. In the case of a utility structure 2 comprising a single tubular structure, the diameter of the tubular structure is widest near the ground and decreases along the length of the tubular structure as it extends upwards. In the case of a v-type utility structure that has two legs, as depicted in FIG. 1, the widest point of each of the tubular structures occurs in the middle of each leg at the flange plate 16.

Strakes installed on the sides of utility structures 2 prior to shipment of the sections are frequently damaged during shipment due to the weight of the sections of the utility structure 2. Therefore, we disclose a method of reducing the effects of vortex shedding by attaching strakes to the utility structure 2 after it has been erected. The strakes disclosed herein can also be attached to existing utility structures that need additional vibration damping. Because the strakes are modular, they can easily be transported up the utility structure and installed where required.

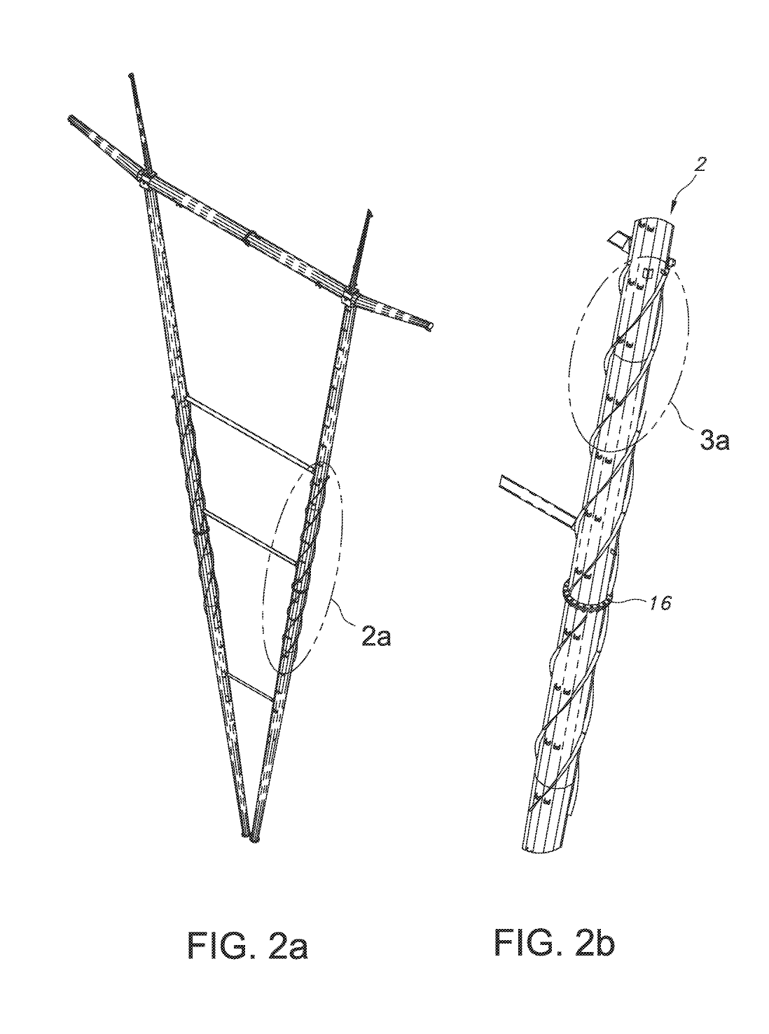

As will be appreciated from FIG. 2, the strakes are preferably in the form of a helical fin 4 that is constructed from thin, flat pieces of metal that are affixed on one edge as they wrap around the utility structure 2. Multiple helical fins 4 can be used to further damp the vibrations caused by wind on the utility structure 2.

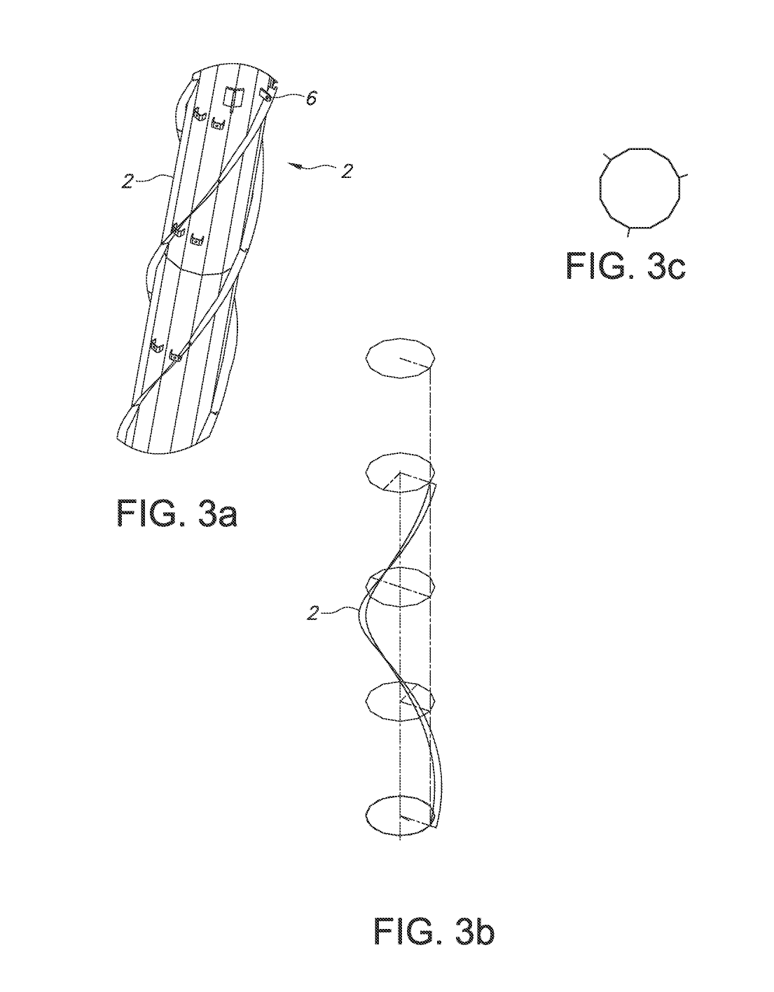

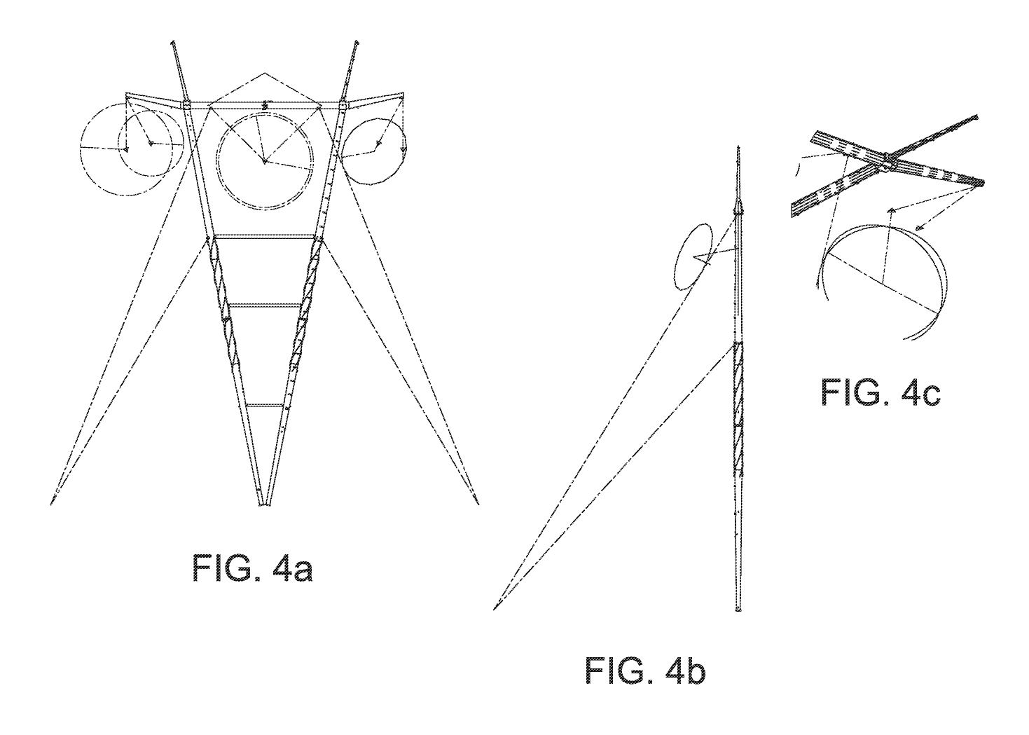

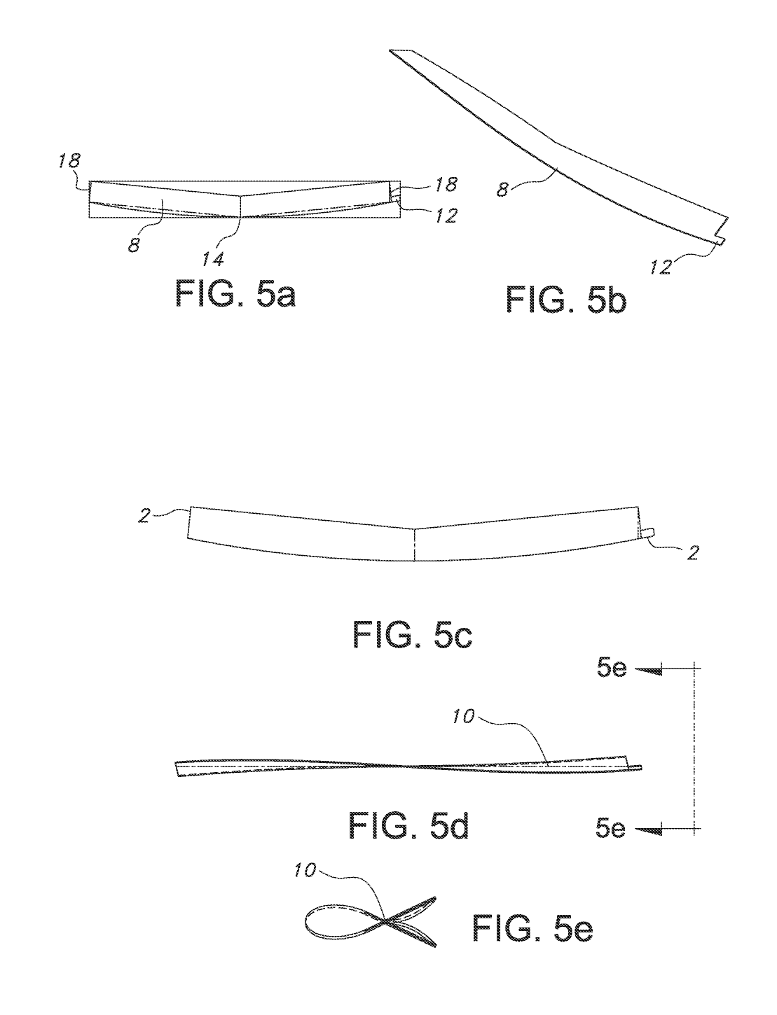

As can be seen from FIG. 3 and FIG. 5, the helical fins 4 are comprised of a series of short sections of light gauge sheet metal, such as 3/16^{th} inch galvanized steel or self-weathering steel that has been intentionally positioned to maximize their effectiveness against wind forces. Each fin section 8 is formed from a flat piece of metal as shown in FIG. 5(a) that is cut such that fin section 8 roughly conforms to the shape of the utility structure 2 at the height at which it is installed. After being cut from the sheet metal, the fin section 8 is twisted along the axis of twist 10, so that it better follows the contour of the utility structure 2 as it winds around it. If the utility structure 2 is tapered, fin sections 8 can be shorter near the top than they are at the bottom of the utility structure 2 to more closely conform to the utility structure 2. In embodiments where the utility structure 2 has a plurality of flat sides (also known as “flats”), the fin section 8 will be configured to cover the width of two flats. To accomplish this, the fin section 8 forms an angle at mid-fin spline point 14 that corresponds to the shape of the utility structure 2. For example, in utility structures 2 that are in the common dodecagon shape at a cross section, fin section 8 forms an angle at mid-fin spline point 14 of 150 degrees. In such case, the width of fin section 8, as measured from the edge closest to the utility structure 2 to the edge farthest from the utility structure 2, is preferably approximately three inches.

In one embodiment, the strakes are attached in a helical pattern, such that they run parallel to each other around the monopole structure. In a preferred embodiment, the strakes form a triple-helix as they circumscribe the monopole structure. In this embodiment, the strakes are positioned such that they start 120 degrees apart from each other, as shown in FIG. 3a. The triple-helical pattern has been shown to significantly reduce vortex shedding and damp the vibrations on the utility structure 2.

Clips 6 are used to hold the helical fin 4 to the utility structure 2. As shown in FIG. 2b and FIG. 3a, the clips 6 may simply be metal brackets that extend from the utility structure 2 and against which the helical fins 4 are attached. The clips 6 are ideally made of metal, such as galvanized steel or self-weathering sheet metal. They can be affixed to the utility structure 2 at the location of installation, or they can be affixed prior to shipping the sections of utility structure 2.

Installation of the helical fins 4 involves determining the location of the clips 6 on the utility structure 2 and attaching clips 6 to the utility structure 2. Finally, the fin sections 8 are attached to the clips 6 and to each other as needed to form the helical fins 4.

To determine the preferred location of each clip 6 around the utility structure 2 such that the helical fins 4 will form a triple helix pattern around the utility structure 2, a string can be used to create a template. One end of a string is positioned at the starting location, and the string is wound around the utility structure 2 so that it spans a certain number of flats over the desired height. In the embodiment pictured in FIG. 3b for the dodecagon utility structure 2, one end of the string would be positioned at approximately six inches above the flange and the string would be rotated across 3 flats, or 90 degrees from the starting point for every five feet that it rises up the utility structure 2. The string would, therefore, make a full revolution in 20 feet. A second string would be started six inches above the starting position of the first string, but four flats (or 120 degrees) over from the first string. It would run parallel to the first string, as it rises five feet for every three flats. The third string would start six inches above the starting point of the second string at a point that is four flats (or 120 degrees) from the other two strings. It, too, would run parallel to the first and second strings as it rises five feet for every three flats. The three strings would form a triple helix as they rise about the utility structure 2.

Once the strings are in position, the intended location of the clips 6 can be marked on the utility structures 2. As can be seen in FIG. 3a, the clips 6 are preferably positioned along the string pattern. However, a large degree of tolerance is permitted to allow for deviation from the string pattern or to accommodate interferences (such as ladder rungs). In one embodiment, the individual string sections can permit a tolerance of six inches up or down the utility structure 2 to accommodate variations in the pitch. The tolerance allows the helical fin 4 to get back onto the string pattern. Once the positions of the clips 6 have been identified, they can then be secured to the utility structure 2, preferably by welding directly to the utility structure 2.

The fin sections 8 have a relatively short width, as measured from the edge closest to the utility structure 2 to the edge farthest from the utility structure 2. This allows the fin sections 8 to be positioned under ladder rungs and other obstacles so that interruption in the helical fin 4 can be avoided. However, it should be appreciated that the modular construction of the helical fin 4 allows it to accommodate interferences, such as ladder rungs or other objects. In the case of such interference, that particular fin section 8 may be omitted. Alternatively, the fin section 8 may be split into two portions at the mid-fin spline point 14 as shown in FIG. 5a. The portion of fin section 8 that does not encounter interference can then be attached to a clip 6 on the utility structure 2 as close as possible to the interference. The helical fin 4 can resume after the interference with each fin section 8 securely fastened against the utility structure 2.

As fin sections 8 are secured into the clips 6, each fin section 8 is preferably affixed to the next by means of the overlap tab 12, shown in FIGS. 5a and 5b. The overlap tab 12 is a small protrusion of metal extending beyond the fin section short edge 18, which, as used herein, describes the shorter sides of the fin section 8 as shown in FIG. 5a. Although the overlap tab 12 is shown as protruding over on just one fin section short edge 18, it is anticipated that it can be included on either or both fin section short edges 18 of the fin section 8. The overlap tab 12 is configured such that it will overlap with an adjacent fin section 8. The overlap tab 12 can then be affixed to the adjacent fin section 8, preferably by spot welding, in order to secure the two fin sections 8 together.

It should also be appreciated that the modular construction of the helical fins 4 allows for easier installation of the strakes on the utility structures 2. Rather than trying to wind a single large band of metal around the utility structure 2, the individual fin sections can be carried up the utility structure 2 as needed. Attaching individual fin sections 8 to the utility structure 2 is significantly less cumbersome to work with compared to a large single helical fin 4.

It is anticipated that all of the components of the strake, including the clips 6 and fin sections 8, can be sold as a kit for reducing vibrations on utility structures 2. Additionally, it may include lengths of string for creating a template on the utility structure 2.

When fully assembled on the utility structure 2, the helical fins 4 will serve to reduce wind forces due to vortex shedding, thus preventing damage to the utility structure 2.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

We claim:

1. An apparatus for reducing vortex-induced vibrations on a utility structure comprising:
a. a first fin section configured to partially surround the perimeter of the utility structure, said first fin section comprising a strip of sheet metal that extends outward from said utility structure; and
b. a second fin section configured to partially surround the perimeter of the utility structure, said second fin section comprising a strip of sheet metal that extends outward from said utility structure;
wherein said first fin section and said second fin section are attached at a point where said first fin section and said second fin section overlap.

2. The apparatus of claim 1 wherein said first fin section and said second fin section are attached by welding.

3. The apparatus of claim 1 wherein said first fin section includes a protruding tab configured to overlap with said second fin section.

4. The apparatus of claim 1 wherein said second fin section includes a protruding tab configured to overlap with said first fin section.

5. The apparatus of claim 1 further comprising a first clip for attaching said first fin section to said utility structure and said second clip for attaching said second fin structure.

6. The apparatus of claim 5 wherein said first clip and said second clip are each made of metal.

7. The apparatus of claim 1 wherein said first fin section and said second fin section are made of self-weathering steel.

8. The apparatus of claim 1 wherein said first fin section and said second fin section are made of galvanized steel.

9. A method for attaching a strake on a utility structure comprising:
a. positioning a first clip and a second clip to the perimeter of said utility structure;
b. securing said first clip and said second clip to the perimeter of said utility structure;
c. securing a first fin section of said strake to said first clip;
d. securing said first fin section to a second fin section of said strake; and
e. securing said second fin section to said second clip.

10. The method of claim 9 wherein said first clip and said second clip are welded to said utility structure.

11. The method of claim 9 wherein said first clip is welded to said first fin section and wherein said second clip is welded to said second fin section.

12. The method of claim 9 wherein the step of positioning a first clip and a second clip to the perimeter of said utility structure is further comprised of :
a. winding a string around said utility structure such that said string approximately forms a helical shape;
b. marking attachment points along the path created by said string for securing said clips.

13. A device for reducing vortex-induced vibrations on a utility structure comprising a first helical strake wherein said helical strake is comprised of overlapping fin sections welded together and secured to said utility structure.

14. The device of claim 13 further comprising:
a second helical strake wherein said second helical strake is comprised of overlapping fin sections welded together and secured to said utility structure; and
a third helical strake wherein said third helical strake is comprised of overlapping fin sections welded together and secured to said utility structure,
wherein said first helical strake, said second helical strake, and said third helical strake are approximately equidistant from each other at a cross section of said utility structure.

15. The device of claim 14 wherein said first helical strake, said second helical strake, and said third helical strake are each secured to said utility structure by welding a retention clip to a fin section and to said utility structure.

16. The device of claim 13 wherein each of said fin sections is made of sheet metal.

17. The device of claim 16 wherein said sheet metal is galvanized steel.

18. The device of claim 16 wherein said sheet metal is self-weathering steel.

19. The device of claim 14 wherein each of said fin sections is made of sheet metal.

20. The device of claim 19 wherein said sheet metal is galvanized steel.

21. The device of claim 19 wherein said sheet metal is self-weathering steel.
